(19) United States
(12) Patent Application Publication
(10) Pub. No.: US 2021/0165692 A1
(43) Pub. Date: Jun. 3, 2021

(54) METHOD, APPARATUS, AND STORAGE MEDIUM FOR PROCESSING RESOURCE ALLOCATION DATA

(71) Applicant: BEIJING SENSETIME TECHNOLOGY DEVELOPMENT CO., LTD., Beijing (CN)

(72) Inventor: Xueqi ZHOU, Beijing (CN)

(21) Appl. No.: 17/123,180

(22) Filed: Dec. 16, 2020

Related U.S. Application Data
(63) Continuation of application No. PCT/CN2020/112702, filed on Aug. 31, 2020.

(30) Foreign Application Priority Data
Nov. 29, 2019 (CN) 201911205884.3

(51) Int. Cl. G06F 9/50; G06F 9/46

(52) U.S. Cl. CPC G06F 9/5016; G06F 9/466; G06F 9/5044

(57) ABSTRACT

The embodiments of the present disclosure provide a method, apparatus, and storage medium for processing resource allocation data. The method comprises: acquiring popularity and transaction volume of a target vehicle type in a target site within a preset time range; evaluating resource allocation data of the target vehicle type based on the popularity and the transaction volume to obtain an evaluation result of the resource allocation data; and adjusting the resource allocation data or outputting a resource adjustment suggestion corresponding to the evaluation result, according to the evaluation result.

### CROSS-REFERENCE TO RELATED APPLICATION

The present disclosure is a continuation of and claims priority under 35 U.S.C. § 120 to PCT Application No. PCT/CN2020/112702, filed on Aug. 31, 2020, which claims priority to Chinese Patent Application No. 201911205884.3, filed with National Intellectual Property Administration, PRC, on Nov. 29, 2019, entitled “Method, apparatus and Storage Medium for Processing Resource Allocation Data”. All the above referenced priority documents are incorporated herein by reference in their entireties.

### TECHNICAL FIELD

The present disclosure relates to the field of computer vision, and in particular, to a method, apparatus, and storage medium for processing resource allocation data.

### BACKGROUND

In practical applications (e.g., vehicle sales, among other sites), data of successful transactions is often sorted out by people, in order for resource allocation in the current site to be adjusted based on the sorted data. However, manual data sorting is not only time-consuming and labor-intensive, but it is also often difficult to determine a core factor that affects the transaction volume, based on a result of the data sorting. Therefore, a method for processing resource allocation data is urgently needed to solve the technical problem described above.

### SUMMARY

Embodiments of the present disclosure aim to provide a technical solution of a method for processing resource allocation data.

As a first aspect, embodiments of the present disclosure provide a method for processing resource allocation data, the method comprising: acquiring popularity and transaction volume of a target vehicle type in a target site within a preset time range; evaluating resource allocation data of the target vehicle type based on the popularity and the transaction volume to obtain an evaluation result of the resource allocation data; and adjusting the resource allocation data or outputting a resource adjustment suggestion corresponding to the evaluation result, according to the evaluation result.

In a possible implementation, evaluating resource allocation data of the target vehicle type based on the popularity and the transaction volume to obtain an evaluation result of the resource allocation data comprises: obtaining a first comparison result according to a relationship in magnitude between the popularity and preset popularity; obtaining a second comparison result according to a relationship in magnitude between the transaction volume and preset transaction volume; and determining the evaluation result based on the first comparison result and the second comparison result.

In a possible implementation, the preset time range includes a first preset time range and a second preset time range; evaluating resource allocation data of the target vehicle type based on the popularity and the transaction volume to obtain an evaluation result of the resource allocation data comprises: determining a first change trend of the popularity within the first preset time range with respect to the popularity within the second preset time range; determining a second change trend of the transaction volume within the first preset time range with respect to the transaction volume within the second preset time range; and determining the evaluation result based on the first change trend and the second change trend.

In a possible implementation, the evaluation result includes at least two levels; resource allocation data to be adjusted that corresponds to different levels varies in type, and/or resource allocation data to be adjusted that corresponds to different levels is adjusted in different ways.

In a possible implementation, determining the evaluation result based on the first comparison result and the second comparison result comprises at least one of: determining that the evaluation result is a first evaluation result in a case where the first comparison result indicates that the popularity is greater than or equal to the preset popularity, and the second comparison result indicates that the transaction volume is less than the preset transaction volume; determining that the evaluation result is a second evaluation result in a case where the first comparison result indicates that the popularity is less than the preset popularity, and the second comparison result indicates that the transaction volume is greater than or equal to the preset transaction volume; and determining that the evaluation result is a third evaluation result in a case where the first comparison result indicates that the popularity is less than the preset popularity, and the second comparison result indicates that the transaction volume is less than the preset transaction volume.

In a possible implementation, determining the evaluation result based on the first change trend and the second change trend comprises at least one of: determining that the evaluation result is a first evaluation result in a case where the first change trend is an upward trend and the second trend is a downward trend; determining that the evaluation result is a second evaluation result in a case where the first change trend is a downward trend and the second trend is an upward trend; and determining that the evaluation result is a third evaluation result in a case where the first change trend is a downward trend and the second trend is a downward trend.

In a possible implementation, adjusting the resource allocation data according to the evaluation result comprises at least one of: adjusting contents of the resource allocation data in a case where the evaluation result includes the first evaluation result, wherein the resource allocation data includes online resource allocation data and/or offline resource allocation data; adjusting contents of the offline resource allocation data in a case where the evaluation result includes the second evaluation result; and adjusting contents of the online resource allocation data and the offline resource allocation data in a case where the evaluation result includes the third evaluation result.

In a possible implementation, the contents of the offline resource allocation data include at least one of a placement location, selling price, after-sales service, and push method of resource allocation data of the target vehicle type; and/or the contents of the online resource allocation data include at least one of a presentation location of relevant information, selling price, after-sales service, and push method of resource allocation data of the target vehicle type; and/or the push method of resource allocation data includes at least one of a push time of resource allocation data, an interval between two consecutive pushes of resource allocation data, and a route to push resource allocation data.

In a possible implementation, acquiring popularity of a target vehicle type in a target site within a preset time range comprises: determining a total length of stay corresponding to the target vehicle type based on video images of a plurality of persons on a visit within the preset time range; and determining the popularity of the target vehicle type based on the total length of stay corresponding to the target vehicle type.

In a possible implementation, determining a total length of stay corresponding to the target vehicle type based on video images of a plurality of persons on a visit within the preset time range comprises: determining a vehicle type area where a target person is located, based on location information of an area where the target person appears and location information of an area where the target vehicle type is located, in the plurality of video images; determining a length of stay of the target person in the area where the target vehicle type is located in the plurality of video images, according to a capture time of the plurality of video images and the vehicle type area where the target person is located; and determining a total length of stay corresponding to the target vehicle type according to lengths of stay of a plurality of the target persons in the area where the target vehicle type is located.

In a possible implementation, the method is applied to a server; outputting a resource adjustment suggestion corresponding to the evaluation result according to the evaluation result comprises: sending the resource adjustment suggestion corresponding to the evaluation result to a terminal in order for the terminal to display at least part of the resource adjustment suggestion via a display interface.

In a possible implementation, the method is applied to a terminal; outputting a resource adjustment suggestion corresponding to the evaluation result according to the evaluation result comprises: displaying at least part of the resource adjustment suggestion corresponding to the evaluation result via a display interface of the terminal.

As a second aspect, embodiments of the present disclosure provide an apparatus for processing resource allocation data, the apparatus comprising: an acquisition module configured to acquire popularity and transaction volume of a target vehicle type in a target site within a preset time range; an evaluation module configured to evaluate resource allocation data of the target vehicle type based on the popularity and the transaction volume to obtain an evaluation result of the resource allocation data; and an execution module configured to adjust the resource allocation data or output a resource adjustment suggestion corresponding to the evaluation result, according to the evaluation result.

In a possible implementation, the evaluation module is configured to obtain a first comparison result according to a relationship in magnitude between the popularity and preset popularity; obtain a second comparison result according to a relationship in magnitude between the transaction volume and preset transaction volume; and determine the evaluation result based on the first comparison result and the second comparison result.

In a possible implementation, the preset time range includes a first preset time range and a second preset time range; the evaluation module is configured to determine a first change trend of the popularity within the first preset time range with respect to the popularity within the second preset time range; determine a second change trend of the transaction volume within the first preset time range with respect to the transaction volume within the second preset time range; and determine the evaluation result based on the first change trend and the second change trend.

In a possible implementation, the evaluation result includes at least two levels; resource allocation data to be adjusted that corresponds to different levels varies in type, and/or resource allocation data to be adjusted that corresponds to different levels is adjusted in different ways.

In a possible implementation, the evaluation module is configured to determine the evaluation result based on the first comparison result and the second comparison result by doing at least one of: determining that the evaluation result is a first evaluation result in a case where the first comparison result indicates that the popularity is greater than or equal to the preset popularity, and the second comparison result indicates that the transaction volume is less than the preset transaction volume; determining that the evaluation result is a second evaluation result in a case where the first comparison result indicates that the popularity is less than the preset popularity, and the second comparison result indicates that the transaction volume is greater than or equal to the preset transaction volume; and determining that the evaluation result is a third evaluation result in a case where the first comparison result indicates that the popularity is less than the preset popularity, and the second comparison result indicates that the transaction volume is less than the preset transaction volume.

In a possible implementation, the evaluation module is configured to determine the evaluation result based on the first change trend and the second change trend by doing at least one of: determining that the evaluation result is a first evaluation result in a case where the first change trend is an upward trend and the second trend is a downward trend; determining that the evaluation result is a second evaluation result in a case where the first change trend is a downward trend and the second trend is an upward trend; and determining that the evaluation result is a third evaluation result in a case where the first change trend is a downward trend and the second trend is a downward trend.

In a possible implementation, the execution module is configured to adjust the resource allocation data according to the evaluation result by doing at least one of: adjusting contents of the resource allocation data in a case where the evaluation result includes the first evaluation result, wherein the resource allocation data includes online resource allocation data and/or offline resource allocation data; adjusting contents of the offline resource allocation data in a case where the evaluation result includes the second evaluation result; and adjusting contents of the online resource allocation data and the offline resource allocation data in a case where the evaluation result includes the third evaluation result.

In a possible implementation, the contents of the offline resource allocation data include at least one of a placement location, selling price, after-sales service, and push method of resource allocation data of the target vehicle type; and/or the contents of the online resource allocation data include at least one of a presentation location of relevant information, selling price, after-sales service, and push method of resource allocation data of the target vehicle type; and/or the push method of resource allocation data includes at least one of a push time of resource allocation data, an interval between two consecutive pushes of resource allocation data, and a route to push resource allocation data.

In a possible implementation, the acquisition module is configured to determine a total length of stay corresponding to the target vehicle type based on video images of a plurality of persons on a visit within the preset time range; and determine the popularity of the target vehicle type based on the total length of stay corresponding to the target vehicle type.

In a possible implementation, the acquisition module is configured to determine a vehicle type area where a target person is located, based on location information of an area where the target person appears and location information of an area where the target vehicle type is located, in the plurality of video images; determine a length of stay of the target person in the area where the target vehicle type is located in the plurality of video images, according to a capture time of the plurality of video images and the vehicle type area where the target person is located; and determine a total length of stay corresponding to the target vehicle type according to lengths of stay of a plurality of the target persons in the area where the target vehicle type is located.

In a possible implementation, the apparatus is applied to a server; the execution module is configured to send the resource adjustment suggestion corresponding to the evaluation result to a terminal in order for the terminal to display at least part of the resource adjustment suggestion via a display interface.

In a possible implementation, the apparatus is applied to a terminal; the execution module is configured to display at least part of the resource adjustment suggestion corresponding to the evaluation result via a display interface of the terminal.

As a third aspect, embodiments of the present disclosure provide an apparatus for processing resource allocation data, the apparatus comprising: a memory, a processor, and a computer program that is stored in the memory and runnable on the processor, wherein when the processor executes the program, the steps of the methods for processing resource allocation data that are described in the embodiments of the present disclosure are carried out.

As a fourth aspect, embodiments of the present disclosure provide a computer storage medium storing a computer program which, when executed by a processor, causes the processor to carry out the steps of the methods for processing resource allocation data that are described in the embodiments of the present disclosure.

As a fifth aspect, embodiments of the present disclosure further provide a computer program causing a computer to execute the methods for processing resource allocation data that are described in the embodiments of the present disclosure.

The embodiments of the present disclosure provide a technical solution that comprises: acquiring popularity and transaction volume of a target vehicle type in a target site within a preset time range; evaluating resource allocation data of the target vehicle type based on the popularity and the transaction volume to obtain an evaluation result of the resource allocation data; and adjusting the resource allocation data or outputting a resource adjustment suggestion corresponding to the evaluation result, according to the evaluation result. This technical solution saves the time spent in data sorting, that is, it solves the time-consuming and labor-intensive problem caused by manual data sorting. Besides, transaction volume is data that can directly reflect successful transactions, and popularity is data that has a big impact on the transaction volume. Thus, the combination of popularity and transaction volume can effectively reflect whether resource allocation of a target vehicle type is reasonable, so that the evaluation result is more pertinent, that is, resource allocation of only a target vehicle type is analyzed. In this way, it is possible to get an evaluation result of the resource allocation data of the target vehicle type based on the acquired data and thereby possible to adjust the resource allocation data (that is, resource allocation) of the target vehicle type reasonably based on the evaluation result. This means that the embodiments of the present disclosure make it possible to know data on popularity and transaction volume of a target vehicle type with higher accuracy, provide an evaluation result of the resource allocation data of the target vehicle type, and further provide a reasonable adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, such that customer experience and sales conversion rate can be further improved.

### BRIEF DESCRIPTION OF THE DRAWINGS

FIG. 1 is an implementation flow schematic diagram of one method for processing resource allocation data according to an embodiment of the present disclosure.

FIG. 2 is an implementation flow schematic diagram of another method for retrieving samples according to an embodiment of the present disclosure.

FIG. 3 is a schematic diagram of a display interface of popularity of vehicle types that is provided by an embodiment of the present disclosure.

FIG. 4 is a schematic diagram of the composition structure of one apparatus for processing resource allocation data according to an embodiment of the present disclosure.

FIG. 5 is a schematic diagram of the composition structure of another apparatus for processing resource allocation data according to an embodiment of the present disclosure.

FIG. 6 is a schematic diagram of the hardware composition structure of an apparatus for processing resource allocation data that is provided by an embodiment of the present disclosure.

### DETAILED DESCRIPTION

In order for those skilled in the art to better understand the solutions of embodiments of the present disclosure, the technical solutions in the embodiments of the present disclosure will be clearly described in conjunction with the accompanying drawings of the embodiments of the present disclosure. Evidently, the embodiments described later are only part of embodiments of the present disclosure, not all embodiments of the present disclosure.

The terms “first,” “second,” and “third”, etc. in the embodiments described in the specification and those in the claims and drawings in the present disclosure are used to distinguish similar objects, not used to describe a specific order or precedence order. The terms “comprise” and “have” and variants thereof are intended to cover non-exclusive inclusion, e.g., inclusion of a series of steps or units. A method, system, product, or device is not necessarily limited to those steps or units that are clearly listed, but may include other steps or units that are not clearly listed or are inherent to the method, system, product, or device.

An embodiment of the present disclosure, which is applicable to various electronic devices, provides a method for processing resource allocation data. The electronic devices include, but are not limited to, a fixed device and/or a mobile device. For example, the fixed device includes, but is not limited to, a personal computer (PC), or a server. The server may be a cloud server or an ordinary server. The mobile device includes, but is not limited to, one or more of a mobile phone, a tablet computer, or a wearable device. As shown in FIG. 1, the method primarily comprises the following steps:

step 101 of acquiring popularity and transaction volume of a target vehicle type in a target site within a preset time range;

step 102 of evaluating resource allocation data of the target vehicle type based on the popularity and the transaction volume to obtain an evaluation result of the resource allocation data; and

step 103 of adjusting the resource allocation data or outputting a resource adjustment suggestion corresponding to the evaluation result, according to the evaluation result.

In embodiments of the present disclosure, the target site may generally refer to an area where vehicles can be exhibited, including but not limited to a 4S car sales service store, or a car shopping mall.

In embodiments of the present disclosure, the preset time range may include a period of time starting at a start time and ending at an end time, such as one day, one week, one month, one quarter, half a year, one year, etc. The preset time range may be determined according to actual needs. The present disclosure does not limit how to set the preset time range or what value it is. It should be noted that the end time is a time before the current moment.

In embodiments of the present disclosure, the popularity refers to the degree of attention (or the degree of being paid attention) to the target vehicle type. As an example, the popularity of a target vehicle type may be expressed by a total length of stay corresponding to the target vehicle type, and the total length of stay is determined by the sum of lengths of stay of respective target persons in a vehicle type area corresponding to the target vehicle type. Alternatively, the popularity of the target vehicle type may be expressed by various acceptable variants of the total length of stay. The greater the total length of stay is, the higher the popularity is; vice versa. For example, assume that the preset time range is the time range from 10:00 am to 18:00. If a total of 20 target persons have had a stay in a vehicle type area corresponding to target vehicle type 1, and each of the target persons has stayed for 20 minutes, then the total length of stay corresponding to target vehicle type 1 is 400 minutes. If a total of 10 target persons have had a stay in a vehicle type area corresponding to target vehicle type 2, and each of the target persons has stayed for 5 minutes, then the total length of stay corresponding to target vehicle type 2 is 50 minutes. Thus, it is indicated that the popularity of target vehicle type 1 is higher than that of target vehicle type 2.

In embodiments of the present disclosure, the transaction volume refers to the number of transactions of vehicles of the target vehicle type within a time unit. That is also the number of transactions of vehicles of the target vehicle type within a preset time range, or the number of vehicles of the target vehicle type sold within a preset time range. For example, the transaction volume of A-type vehicles in one month is 80, and the transaction volume of A-type vehicles in the first quarter is 300.

In embodiments of the present disclosure, the resource allocation data may be resource allocation data concerning activities of selling a target vehicle type. In some of the embodiments, the resource allocation data may be data used to reflect resources in a resource allocation plan adopted for a target vehicle type. For example, the resource allocation data includes, but is not limited to, one or a combination of quantity allocation, time allocation, spatial allocation, personnel allocation, and information network allocation, etc. The above quantity allocation may include the quantity of vehicles of a target vehicle type to be sold. The above time allocation may include a time allocated for a target vehicle type to be sold, and the time may be expressed in at least one time dimension of year, quarter, month, date, and hour. The above spatial allocation may include a placement location in a target site where a target vehicle type to be sold is arranged. The above personnel allocation may include allocation information of personnel for a target vehicle type to be sold, etc., and it may include, for example, the number of sales personnel for a target vehicle type to be sold. The above information network allocation may include contents of recommendation information of a target vehicle type to be sold and/or a recommendation site in a target site or a recommendation site on a network. The recommendation site in a target site can be understood as a recommendation site of a physical advertisement in the target site, such as a paper-based advertisement recommendation or a recommendation on each electronic screen in the target site. The recommendation site on a network can be understood as an advertisement recommendation site on a network platform, among others.

In embodiments of the present disclosure, the evaluation result may be used to reflect the degree of the impact of the current resource allocation data on the transaction volume after the current resource allocation data has been allocated for a period of time. As an example, the evaluation result may include a change in transaction volume of a target vehicle type after the resource allocation data has been allocated for a period of time.

In some embodiments, adjusting the resource allocation data comprises subjecting the resource allocation data to matching, flowing and reorganizing in respect of quantity, time and space.

In some embodiments, outputting a resource adjustment suggestion corresponding to the evaluation result comprises outputting a resource adjustment suggestion for subjecting the resource allocation data to matching, flowing and reorganizing in respect of quantity, time and space.

The embodiments of the present disclosure provide a technical solution that comprises: acquiring popularity and transaction volume of a target vehicle type in a target site within a preset time range; evaluating resource allocation data of the target vehicle type based on the popularity and the transaction volume to obtain an evaluation result of the resource allocation data; and adjusting the resource allocation data or outputting a resource adjustment suggestion corresponding to the evaluation result, according to the evaluation result. Thus, this technical solution saves the time spent in data sorting, that is, it solves the time-consuming and labor-intensive problem caused by manual data sorting. Moreover, transaction volume is data that can directly reflect successful transactions, and popularity is data that has a big impact on the transaction volume. Thus, the combination of popularity and transaction volume effectively reflects whether resource allocation of a target vehicle type is reasonable, and makes the evaluation result more pertinent, that is, resource allocation of only a target vehicle type needs to be analyzed. In this way, it is possible to get an evaluation result of the resource allocation data of the target vehicle type based on the acquired data and thereby possible to reasonably adjust the resource allocation data (that is, how to allocate the resource) of the target vehicle type based on the evaluation result. This also means that the embodiments of the present disclosure make it possible to know data on popularity and transaction volume of a target vehicle type with higher accuracy, provide an evaluation result of the resource allocation data of the target vehicle type, and provide a reasonable resource adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, so that customer experience and sales conversion rate can be further improved.

Considering that a target site is usually provided with a plurality of image pickup apparatuses, so it is possible to know popularity and transaction volume of a target vehicle type in the target site within a preset time range through video images captured by the image pickup apparatuses. Therefore, in some of the embodiments, step 101 may comprise:

step 1011 of determining total length of stay corresponding to the target vehicle type based on video images of a plurality of persons on a visit within the preset time range; and

step 1012 of determining the popularity of the target vehicle type based on the total length of stay corresponding to the target vehicle type.

In a possible implementation, step 1011 comprises:

step 1011a of determining a vehicle type area where a target person is located, based on location information of an area where the target person appears and location information of an area where the target vehicle type is located, in the plurality of video images;

step 1011b of determining a length of stay of the target person in the area where the target vehicle type is located in the plurality of video images, according to a capture time of the plurality of video images and the vehicle type area where the target person is located; and

step 1011c of determining total length of stay corresponding to the target vehicle type according to lengths of stay of a plurality of the target persons in the area where the target vehicle type is located.

It can be appreciated that the target person may include a person other than those listed in a whitelist.

The whitelist may include a person who has little or no impact on the transaction volume. Generally, those belonging to the whitelist do not include a customer who visits the target site. For example, the whitelist may include at least one of 4S shop employees, cleaners, maintenance workers, package couriers, takeout couriers, and so on. It should be noted that the persons in the whitelist can be set or adjusted according to needs of a manager in the target site.

In an optional embodiment, to recognize a video image captured by an image pickup apparatus, the first thing is to determine whether a currently recognized object belongs to the whitelist. If so, the currently recognized object is ignored; if not, the currently recognized object is determined as the target person, and lengths of stay of the target person in areas where a plurality of target vehicle types are located are recorded and analyzed, respectively.

In this embodiment, the area where the target vehicle type is located is greater than or equal to the area occupied by the body of the vehicle of the vehicle type. The area where the vehicle type is located may be automatically determined by the system or manually determined by the staff member. In practical applications, the area where each target vehicle type is located can have an independent identifier such a number, and the identifier is associated with the area where the vehicle type is located. Each vehicle type may correspond to a plurality of areas.

It should be noted that, in one embodiment, the correspondence between the vehicle type and the area may be determined based on manual settings by the user; in another embodiment, the correspondence between the vehicle type and the area may be determined based on the automatic settings of the system. For example, the system may automatically determine a vehicle type based on the shape of the vehicle body, determine an identifier corresponding to the vehicle type, and associate the area with the identifier corresponding to the vehicle type based on the area where the vehicle is located.

In some embodiments, each vehicle type corresponds to one area. As an example, Haval H6 vehicles are exhibited in Area 1, Haval H7 vehicles are exhibited in Area 2, Haval M6 vehicles are exhibited in Area 3, and Haval F7 vehicles are exhibited in Area 4.

In other embodiments, the same vehicle type may correspond to one or more areas. As an example, Haval H6 vehicles are exhibited in Area 1 and Area 2, Haval H7 vehicles are exhibited in Area 3 and Area 4, Haval M6 vehicles are exhibited in Area 5, and Haval F7 vehicles are exhibited in Area 6.

In some embodiments, the relationship between the vehicle type and the area may be predetermined. For example, the relationship between the vehicle type and the area may be set by the manager of the target site, or determined based on the location of the vehicle.

In some embodiments, determining a length of stay of one of the target persons in the area where the target vehicle type is located comprises: in response to the adjacent appearance of the target person in the area where the target vehicle type is located and a time difference corresponding to the adjacent appearance being less than or equal to a preset time threshold, including the time difference corresponding to the adjacent appearance into a length of stay of the target person in the area where the target vehicle type is located.

In other embodiments, determining a length of stay of one of the target persons in the area where the target vehicle type is located comprises: in response to a time difference corresponding to adjacent appearance of the target person in the area where the target vehicle type is located being greater than a preset time threshold, determining to not include the time difference corresponding to the adjacent appearance into a length of stay of the target person in the area where the target vehicle type is located.

It should be noted that the preset time threshold may be set or adjusted according to actual conditions or the needs of the data maintenance personnel.

For example, assume that the preset time threshold is 5 min; a front-end server responsible for image pickup and image recognition sends a message every one minute to a background server responsible for vehicle type analysis, the message containing time information and location information of each target person; the background server receives a message about information on target person D's visit, specifically including target person D's appearance in the first vehicle type area at 9:00, and receives at the seventh minute information about target person D's visit, specifically including target person D's appearance in the first vehicle type area at 9:07, but at each time point from 9:00 to 9:07, the background server does not receive a message about target person D. Then the background server determines that target person D is actually only captured by chance, and does not record the length of stay of target person D.

As another example, assume that at the first minute, the background server receives information about target person B's visit, specifically including target person B's appearance in the first vehicle type area at 9:01, and receives at the second minute information about target person B's visit, specifically including target person B's appearance in the second vehicle type area at 9:02, but at the 3rd, 4th, 5th, 6th, and 7th minutes, the background server does not receive a message about target person B. Then the background server determines that target person B has actually left, and does not record the length of stay of target person B. As still another example, assume that at the first minute, the background server receives information about target person C's visit, specifically including target person C's appearance in the first vehicle type area at 9:01, and receives at the second minute information about target person C's visit, specifically including target person C's appearance in the second vehicle type area at 9:02, but at the 3rd, 4th, 5th, 6th, and 7th minutes, the background server does not receive a message about target person C. Then the background server determines that the length of stay of target person C in the first vehicle type area is 1 min.

In this way, a length of stay of each target person in the vehicle type area is determined by setting a preset time threshold, so that a more reasonable and accurate data basis is provided for determining a vehicle type that interests a target person.

To make it easy to count the length of stay, in some embodiments, each vehicle type area is provided with an independent accumulator. The accumulator accumulates lengths of stay of target persons in the vehicle type area in unit of a set time period to obtain an accumulated length of stay of the vehicle type area in the set time period. A total length of stay of the vehicle type area is then obtained by accumulating the accumulated lengths of stay of the vehicle type area in at least one of the set time periods within the present time range. Further, in response to the expiration of the set time period, the accumulator is reset.

It should be noted that the set time period may be set or adjusted according to the needs of the data maintenance personnel.

For the purpose of guaranteeing real-time data, to take one day being set as the set time period for example, each vehicle type has a separate accumulator every day; the value accumulated by the accumulator is stored at the end of every day, and then the accumulator is reset in order to count the length of stay of a target person the next day.

As an example, the preset time range includes 3 set time periods; the accumulated length of stay of the first vehicle type area in the first set time period is t1, the accumulated length of stay of the first vehicle type area in the second set time period is t2, and the accumulated length of stay of the first vehicle type area in the third set time period is t3. Then, the total length of stay of the first vehicle type area within the preset time range is t1+t2+t3.

To provide better services to a single target person, in some embodiments, the method further comprises: determining a vehicle type that interests each target person based on information on a length of stay of each target person for a plurality of target vehicle types. For example, if the length of stay of a target person at target vehicle type 1 is 20 min, and the length of stay of the target person at target vehicle type 2 is 5 min, then it is indicated that the target person is more interested in target vehicle type 1.

Determining a vehicle type that interests a single target person makes it easy for the sales personnel to provide targeted services to the target person when the target person visits next time, thereby improving the target person's experience and sales conversion rate.

In some examples, step 101 may comprise acquiring the transaction volume of the target vehicle type within the preset time range locally or from a first device.

The first device herein is a device that can be connected to the electronic device. In embodiments of the present disclosure, no limitation is imposed on the way in which the first device is connected to the electronic device, which may be a wired or wireless way.

That provides a more accurate data basis for the subsequent step of determining an evaluation result of the resource allocation data of the target vehicle type.

In some embodiments, step 102 comprises:
step 1021 of obtaining a first comparison result according to a relationship in magnitude between the popularity and preset popularity;

step 1022 of obtaining a second comparison result according to a relationship in magnitude between the transaction volume and preset transaction volume; and

step 1023 of determining the evaluation result based on the first comparison result and the second comparison result.

In embodiments of the present disclosure, the preset popularity may refer to desired popularity, and the preset transaction volume may refer to desired transaction volume. The preset popularity and/or preset transaction volume may be set in advance according to the time, labour costs for the target vehicle types, and/or business needs. No limitation is imposed on the way to set them.

In embodiments of the present disclosure, the first comparison result indicates a result of the comparison between the magnitude of the popularity and that of the preset popularity. For example, the first comparison result includes the result that the popularity is greater than or equal to the preset popularity, or the result that the popularity is less than the preset popularity. It can be appreciated that the first comparison result represents whether the current popularity corresponding to the target vehicle type meets the preset popularity (that is, whether it meets the expectation).

In embodiments of the present disclosure, the second comparison result indicates a result of the comparison between the magnitude of the transaction volume and that of the preset transaction volume. For example, the second comparison result includes the result that the transaction volume is greater than or equal to the preset transaction volume, or the result that the traction volume is less than the preset transaction volume. It can be appreciated that the second comparison result represents whether the transaction volume corresponding to the target vehicle type meets the preset transaction volume (that is, whether the transaction meets the expectation).

In a possible implementation, determining the evaluation result based on the first comparison result and the second comparison result comprises at least one of: determining that the evaluation result is a first evaluation result in a case where the first comparison result indicates that the popularity is greater than or equal to the preset popularity, and the second comparison result indicates that the transaction volume is less than the preset transaction volume; determining that the evaluation result is a second evaluation result in a case where the first comparison result indicates that the popularity is less than the preset popularity, and the second comparison result indicates that the transaction volume is greater than or equal to the preset transaction volume; and determining that the evaluation result is a third evaluation result in a case where the first comparison result indicates that the popularity is less than the preset popularity, and the second comparison result indicates that the transaction volume is less than the preset transaction volume.

In this embodiment, the evaluation result includes at least two levels; resource allocation data to be adjusted that corresponds to different levels varies in type, and/or resource allocation data to be adjusted that corresponds to different levels is adjusted in different ways.

It can be appreciated that the first evaluation result, the second evaluation result, and the third evaluation result are different evaluation results, that is, they are evaluation results of different levels.

In this way, it is possible to provide an evaluation result of the resource allocation data of the target vehicle type, which helps to provide an adjustment plan for the resource allocation data of the target vehicle type based on the evaluation result and thus helps the staff member to perform targeted work and services based on the adjustment plan. As a result, customer experience and sales conversion rate can be improved.

In some embodiments, adjusting the resource allocation data according to the evaluation result comprises at least one of: adjusting contents of the resource allocation data in a case where the evaluation result includes the first evaluation result, wherein the resource allocation data includes online resource allocation data and/or offline resource allocation data; adjusting contents of the offline resource allocation data in a case where the evaluation result includes the second evaluation result; and adjusting contents of the online resource allocation data and the offline resource allocation data in a case where the evaluation result includes the third evaluation result.

In some embodiments, outputting a resource adjustment suggestion corresponding to the evaluation result according to the evaluation result comprises at least one of: outputting a first resource adjustment suggestion in a case where the evaluation result includes the first evaluation result, wherein the first resource adjustment suggestion includes adjusting contents of online resource allocation data and/or offline resource allocation data included in the resource allocation data; outputting a second resource adjustment suggestion in a case where the evaluation result includes the second evaluation result, wherein the second resource adjustment suggestion includes adjusting contents of offline resource allocation data included in the resource allocation data; and outputting a third resource adjustment suggestion in a case where the evaluation result includes the third evaluation result, wherein the third resource adjustment suggestion includes adjusting contents of online resource allocation data and offline resource allocation data included in the resource allocation data.

In embodiments of the present disclosure, the term “online” may refer to a business model based on online transactions of goods or services on an e-commerce website. For example, the online resource allocation data includes at least one or a combination of the following: a product presentation location, a product presentation time, advertisement push contents, TV broadcast contents, etc. on the webpage. Of course, it can also include contents more or less than the above-exemplified cases. No limitation is imposed on concrete contents of the online resource allocation data. One may select the same or different online resource allocation data according to different scenarios and requirements.

In examples of the present disclosure, the term “offline” may refer to a business model based on actual experience for goods or services in a physical store. For example, the offline resource allocation data includes at least one or a combination of the following: a placement location of billboards in the physical store, a placement location of products in the physical store, and frequency, time or other contents of displaying objects on screens in the physical store. Of course, it can also include contents more or less than the above-exemplified cases. No limitation is imposed on concrete contents of the offline resource allocation data. One may select the same or different offline resource allocation data according to different scenarios and requirements.

In this way, it is possible to help to guide the adjustment of resource allocation of the target vehicle type based on the adjustment plan of resource allocation data and thus helps the staff member to perform targeted work and services based on the adjustment plan. As a result, customer experience and sales conversion rate can be improved.

In a possible implementation, the contents of the offline resource allocation data may include at least one of a placement location, selling price, after-sales service, and push method of resource allocation data of the target vehicle type. The contents of the online resource allocation data may include at least one of a presentation location of relevant information, selling price, after-sales service, and push method of resource allocation data of the target vehicle type.

The push method of resource allocation data may include at least one of a push time of resource allocation data, an interval between two consecutive pushes of resource allocation data, and a route to push resource allocation data.

As an example, if the popularity within the preset time range is greater than or equal to the preset popularity, and the transaction volume is less than the preset transaction volume (that is, the result is the first evaluation result), the online resource allocation data and/or the offline resource allocation data is adjusted. For example, adjusting contents of the online resource allocation data comprises: lowering the price of the target vehicle type, extending the warranty period, adding auxiliary gifts, increasing cashback, increasing the frequency of message pushes, and so on. As another example, adjusting contents of the offline resource allocation data comprises: swapping the placement location of the target vehicle type with that of a less popular type, lowering the price of the target vehicle type, extending the warranty period, making more effort in gift sending, increasing the frequency of message pushes, and so on.

In the case of the above first evaluation result, a first resource adjustment suggestion is output. The first resource adjustment suggestion includes adjusting online resource allocation data and/or offline resource allocation data. For example, adjusting online resource allocation data included in the first resource adjustment suggestion may comprise: lowering the price of the target vehicle type, extending the warranty period, increasing auxiliary gifts, increasing cashback, increasing the frequency of message pushes, and so on. As another example, adjusting offline resource allocation data included in the first resource adjustment suggestion may comprise: swapping the placement location of the target vehicle type with that of a less popular type, lowering the price of the target vehicle type, extending the warranty period, making more effort in gift sending, increasing the frequency of message pushes, and so on.

As an example, if the popularity within the preset time range is less than the preset popularity, and the transaction volume is greater than or equal to the preset transaction volume (that is, the result is the second evaluation result), contents of offline resource allocation data are adjusted. For example, adjusting contents of offline resource allocation data comprises adjusting the placement location and the like of the target vehicle type by, for example, swapping the placement location of the target vehicle type with that of a more popular type, and increasing the frequency of message pushes.

In the case of the above second evaluation result, a second resource adjustment suggestion is output. The second resource adjustment suggestion includes adjusting contents of offline resource allocation data. For example, adjusting contents of offline resource allocation data included in the second resource adjustment suggestion may comprise: adjusting the placement location of the target vehicle model, and so on.

As an example, if the popularity within the preset time range is less than the preset popularity, and the transaction volume is less than the preset transaction volume (that is, the result of is the third evaluation result), the online resource allocation data and the offline resource allocation data are adjusted. For example, adjusting contents of the online resource allocation data comprises: lowering the price of the target vehicle type, extending the warranty period, adding auxiliary gifts, increasing cashback, increasing the frequency of message pushes, and so on. As another example, adjusting contents of the offline resource allocation data comprises: adjusting the placement location of the target vehicle type such as placing the target vehicle type in a better location from the current location, and increasing the frequency of message pushes.

In the case of the third evaluation result, a third resource adjustment suggestion is output. The third resource adjustment suggestion includes adjusting online resource allocation data and offline resource allocation data. For example, adjusting online resource allocation data included in the third resource adjustment suggestion may comprise: lowering the price of the target vehicle type, extending the warranty period, increasing auxiliary gifts, increasing cashback, increasing the frequency of message pushes, and so on. As another example, adjusting offline resource allocation data included in the third resource adjustment suggestion may comprise adjusting the placement location of the target vehicle type.

It can be appreciated that determining the evaluation result based on the first comparison result and the second comparison result further comprises: determining that the evaluation result is a fourth evaluation result in a case where the first comparison result indicates that the popularity is greater than or equal to the preset popularity, and the second comparison result indicates that the transaction volume is greater than or equal to the preset transaction volume. Further, adjusting the resource allocation data according to the evaluation result further comprises: not adjusting the resource allocation data in view of the fact that the popularity and transaction volume of the target vehicle type have met the expectations, in a case where the evaluation result is the fourth evaluation result. Correspondingly, outputting a resource adjustment suggestion corresponding to the evaluation result according to the evaluation result may comprise: not including any adjustment suggestion in the resource adjustment suggestion in view of the fact that the popularity and transaction volume of the target vehicle type have met the expectations, in a case where the evaluation result is the fourth evaluation result.

In this way, it is possible to save the human and material resources consumed in adjusting the resource allocation data when the staff member provides targeted work and services, thereby saving the data allocation resources and maintenance resources without impairing customer experience and sales conversion rate.

In a possible implementation, the preset time range includes a first preset time range and a second preset time range; step 102 comprises: determining a first change trend of the popularity within the first preset time range with respect to the popularity within the second preset time range; determining a second change trend of the transaction volume within the first preset time range with respect to the transaction volume within the second preset time range;

and determining the evaluation result based on the first change trend and the second change trend.

In embodiments of the present disclosure, the first preset time range is a part of the preset time range; the second preset time range is a part of the preset time range. The union of the first preset time range and the second preset time range is less than or equal to the preset time range.

The start point of the second preset time range is later than the start point of the first preset time range.

In some examples, the first preset time range and the second preset time range may overlap. As an example, the preset time range may be from January 1 to January 30, the first preset time range may be from January 1 to January 20, and the second preset time range is from January 11 to January 30.

In some examples, the second preset time may immediately follow the first preset time range, that is, the first preset time range and the second preset time range are consecutive. As an example, the preset time range may be from January 1 to January 30, the first preset time range may be from January 1 to January 15, and the second preset time range may be from January 16 to January 30.

In some examples, the first preset time range and the second preset time range may be not consecutive. As an example, the preset time range may be from January 1 to January 30, the first preset time range may be from January 1 to January 10, and the second preset time range may be from January 20 to January 30.

In embodiments of the present disclosure, the first change trend indicates a change of the popularity in the first preset time range with respect to the popularity in the second preset time range. For example, the first change trend includes an upward trend; or a downward trend; or a relatively stable change; or no change, i.e., no change trend.

In embodiments of the present disclosure, the second change trend indicates a change of the transaction volume in the first preset time range with respect to the transaction in the second preset time range. For example, the second change trend includes an upward trend; or a downward trend; or a relatively stable change; or no change, i.e., no change trend.

In some optional embodiments, the evaluation result includes at least two levels; resource allocation data to be adjusted that corresponds to different levels varies in type, and/or resource allocation data to be adjusted that corresponds to different levels is adjusted in different ways.

Considering that the change trend can reflect more effectively an impact that adjusting the resource allocation data has on the transaction volume at a certain stage or over a certain period, in an implementation, it is possible to determine the evaluation result of the current resource allocation data based on the change trend. That is, in some embodiments, determining the evaluation result based on the first change trend and the second change trend comprises at least one of: determining that the evaluation result is a first evaluation result in a case where the first change trend is an upward trend and the second trend is a downward trend; determining that the evaluation result is a second evaluation result in a case where the first change trend is a downward trend and the second trend is an upward trend; and determining that the evaluation result is a third evaluation result in a case where the first change trend is a downward trend and the second trend is a downward trend.

In some embodiments, adjusting the resource allocation data according to the evaluation result comprises at least one of: adjusting contents of the resource allocation data in a case where the evaluation result includes the first evaluation result, wherein the resource allocation data includes online resource allocation data and/or offline resource allocation data; adjusting contents of the offline resource allocation data in a case where the evaluation result includes the second evaluation result; and adjusting contents of the online resource allocation data and the offline resource allocation data in a case where the evaluation result includes the third evaluation result.

In some embodiments, outputting a resource adjustment suggestion corresponding to the evaluation result according to the evaluation result comprises at least one of: outputting a first resource adjustment suggestion in a case where the evaluation result includes the first evaluation result, wherein the first resource adjustment suggestion includes adjusting contents of online resource allocation data and/or offline resource allocation data included in the resource allocation data; outputting a second resource adjustment suggestion in a case where the evaluation result includes the second evaluation result, wherein the second resource adjustment suggestion includes adjusting contents of the offline resource allocation data included in the resource allocation data; and outputting a third resource adjustment suggestion in a case where the evaluation result includes the third evaluation result, wherein the third resource adjustment suggestion includes adjusting contents of the online resource allocation data and the offline resource allocation data included in the resource allocation data.

In this way, it is possible to help to guide the adjustment of resource allocation of the target vehicle type based on the adjustment plan of resource allocation data and thus helps the staff member to perform targeted work and services based on the adjustment plan. As a result, customer experience and sales conversion rate can be improved.

In a possible implementation, the contents of the offline resource allocation data include at least one of a placement location, selling price, after-sales service, and push method of resource allocation data of the target vehicle type. The contents of the online resource allocation data include at least one of a presentation location of relevant information, selling price, after-sales service, and push method of resource allocation data of the target vehicle type.

The push method of resource allocation data includes at least one of a push time of resource allocation data, an interval between two consecutive pushes of resource allocation data, and a route to push resource allocation data.

As an example, if the popularity within the first preset time range exhibits an upward trend with respect to that within the second preset time range, and the transaction volume within the first preset time range exhibits a downward trend with respect to that within the second preset time range (that is, the result is the first evaluation result), the online resource allocation data and/or the offline resource allocation data is adjusted. For example, adjusting contents of the online resource allocation data comprises: lowering the price of the target vehicle type, extending the warranty period, adding auxiliary gifts, increasing cashback, increasing the frequency of message pushes, and so on. As another example, adjusting contents of the offline resource allocation data comprises: swapping the placement location of the target vehicle type with that of a less popular type, lowering the price of the target vehicle type, extending the warranty period, making more effort in gift sending, increasing the frequency of message pushes, and so on.

In the case of the above first evaluation result, a first resource adjustment suggestion is output. The first resource adjustment suggestion includes adjusting online resource allocation data and/or offline resource allocation data. For example, adjustment suggestion on the online resource allocation data included in the first resource adjustment suggestion may comprise: lowering the price of the target vehicle type, extending the warranty period, increasing auxiliary gifts, increasing cashback, increasing the frequency of message pushes, and so on. As another example, adjustment suggestion on the offline resource allocation data included in the first resource adjustment suggestion may comprise: swapping the placement location of the target vehicle type with that of a less popular type, lowering the price of the target vehicle type, extending the warranty period, making more effort in gift sending, increasing the frequency of message pushes, and so on.

As an example, if the popularity within the first preset time range exhibits a downward trend with respect to that within the second preset time range, and the transaction volume within the first preset time range exhibits an upward trend with respect to that within the second preset time range (that is, the result is the second evaluation result), contents of offline resource allocation data are adjusted, for example, adjusting the placement location and the like of the target vehicle type such as swapping the placement location of the target vehicle type with that of a more popular type, and increasing the frequency of message pushes.

In the case of the above second evaluation result, a second resource adjustment suggestion is output. The second resource adjustment suggestion comprises adjusting contents of offline resource allocation data. For example, adjustment suggestion on contents of offline resource allocation data included in the second resource adjustment suggestion may comprise: adjusting the placement location of the target vehicle model, and so on.

As an example, if the popularity within the first preset time range exhibits a downward trend with respect to that within the second preset time range, and the transaction volume within the first preset time range exhibits a downward trend with respect to that within the second preset time range (that is, the result is the third evaluation result), contents of online resource allocation data and offline resource allocation data are adjusted. For example, adjusting contents of the online resource allocation data comprises: lowering the price of the target vehicle type, extending the warranty period, adding auxiliary gifts, increasing cashback, increasing the frequency of message pushes, and so on. As another example, adjusting contents of the offline resource allocation data comprises: adjusting the placement location of the target vehicle type, such as placing the target vehicle type in a better position, and increasing the frequency of message pushes.

In the case of the above third evaluation result, a third resource adjustment suggestion is output. The third resource adjustment suggestion includes adjusting online resource allocation data and offline resource allocation data. For example, adjustment suggestion on online resource allocation data included in the third resource adjustment suggestion may comprise: lowering the price of the target vehicle type, extending the warranty period, increasing auxiliary gifts, increasing cashback, increasing the frequency of message pushes, and so on. As another example, adjustment suggestion on offline resource allocation data included in the third resource adjustment suggestion may comprise adjusting the placement location of the target vehicle type.

It can be appreciated that determining the evaluation result based on the first comparison result and the second comparison result further comprises: determining that the evaluation result is a fourth evaluation result in a case where the first comparison result indicates that the first change trend is an upward trend, and the second change trend is an upward trend. Further, adjusting the resource allocation data according to the evaluation result further comprises: not adjusting the resource allocation data in view of the fact that the popularity and transaction volume of the target vehicle type have met the expectations, in a case where the evaluation result is the fourth evaluation result. Correspondingly, outputting a resource adjustment suggestion corresponding to the evaluation result according to the evaluation result may comprise: not including any adjustment suggestion in the resource adjustment suggestion in view of the fact that the popularity and transaction volume of the target vehicle type have met the expectations, in a case where the evaluation result is the fourth evaluation result.

In this way, it is possible to save the human and material resources consumed in adjusting the resource allocation data when the staff member provides targeted work and services, thereby saving the data allocation resources and maintenance resources without impairing customer experience and sales conversion rate.

In order to make it convenient for the staff member in the target site to independently select the preset time range according to requirements of the actual scenario and thereby for them to obtain a more targeted evaluation result and corresponding adjustment plan, in an implementation, the staff member can input query conditions via a terminal to determine a preset time range within which the evaluation result and corresponding adjustment plan are needed. That is, in some embodiments, when the method is applied to a server, the method further comprises: receiving query condition sent by a terminal, wherein the query condition includes at least the preset time range; acquiring popularity and transaction volume of a target vehicle type in a target site within the preset time range, in response to the query condition; evaluating resource allocation data of the target vehicle type, based on the popularity and the transaction volume, to obtain an evaluation result of the resource allocation data; and adjusting the resource allocation data according to the evaluation result.

In this way, it is possible to provide the terminal with query services and provide the terminal with an evaluation result of a vehicle type within a certain time range and an adjustment plan of resource allocation data, which makes it convenient for the staff member to make a work plan based on the evaluation result of the vehicle type and the adjustment plan of the resource allocation data. As a result, customer experience and sales conversion rate can be improved.

The embodiments of the present disclosure provide a technical solution that comprises:

acquiring popularity and transaction volume of a target vehicle type in a target site within a preset time range; evaluating resource allocation data of the target vehicle type based on the popularity and the transaction volume to obtain an evaluation result of the resource allocation data; and adjusting the resource allocation data or outputting a resource adjustment suggestion corresponding to the evaluation result, according to the evaluation result. In this way, it is possible to make it possible to know data on popularity and transaction volume of a target vehicle type with higher accuracy, provide an evaluation result of the resource allocation data of the target vehicle type, and provide a reasonable adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, and customer experience and sales conversion rate can be further improved.

In some examples, the methods described above may be applied to a server. The server may be a cloud server and/or a front-end server. For example, the methods described above are implemented by a front-end server (e.g., a video all-in-one machine) and a cloud server. The front-end server performs face and body tracking on captured images to obtain face and body tracking results, determines which kind of image information is used for pedestrian recognition based on the quality of the face and/or body images, and then sends the determined image information to the cloud server. After receiving the image information sent by the front-end server, the cloud server searches in a corresponding database based on the received image information to obtain a pedestrian recognition result, and sends various processing results to the terminal.

On that basis, in some optional embodiments, outputting a resource adjustment suggestion corresponding to the evaluation result according to the evaluation result comprises: sending the resource adjustment suggestion corresponding to the evaluation result to a terminal in order for the terminal to display at least part of the resource adjustment suggestion via a display interface.

In this embodiment, the server may send, to the terminal, information such as the popularity and transaction volume of the target vehicle type and information such as the evaluation result of the resource allocation data of the vehicle type and the adjustment plan corresponding to the evaluation result in order for the terminal to display such information, which makes it convenient for the relevant staff member to quickly see information such as the current popularity and transaction volume of the target vehicle type, as well as the evaluation result of the resource allocation data of the vehicle type and the adjustment plan corresponding to the evaluation result, and thereby makes it convenient for the relevant staff member to quickly adjust the relevant resource allocation data of the target vehicle type.

In some embodiments, the method is applied to a terminal; outputting a resource adjustment suggestion corresponding to the evaluation result according to the evaluation result comprises: displaying at least part of the resource adjustment suggestion corresponding to the evaluation result via a display interface of the terminal.

In this embodiment, the terminal can display, via the display interface, at least part of information such as the popularity and transaction volume of the target vehicle type and information such as the evaluation result of the resource allocation data of the vehicle type and the adjustment plan corresponding to the evaluation result, so as to make it convenient for the relevant staff member to quickly see information such as the current popularity and transaction volume of the target vehicle type, as well as the evaluation results of the resource allocation data of the vehicle type and the adjustment plan corresponding to the evaluation result, through the display of the above information by the terminal, and thereby makes it convenient for the relevant staff member to quickly adjust the relevant resource allocation data of the target vehicle type.

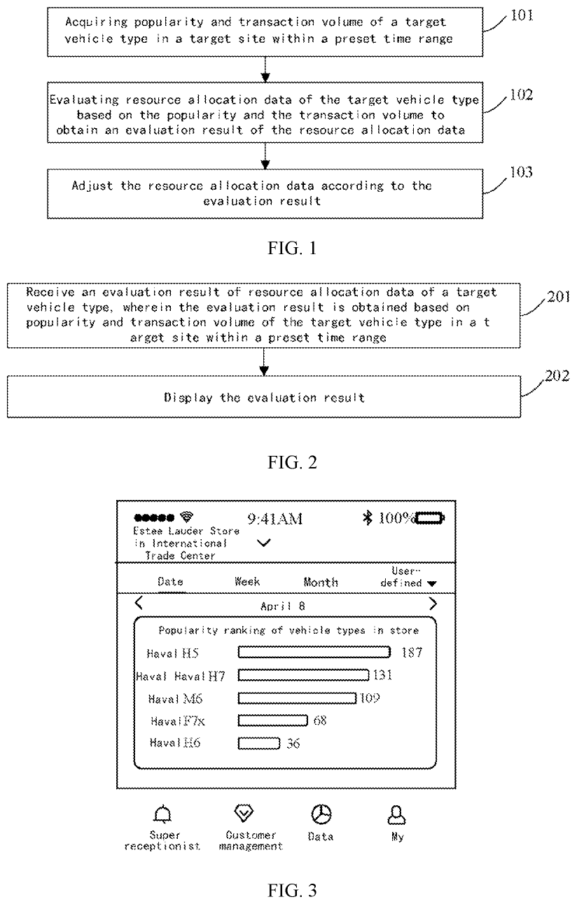

Embodiments of the present disclosure provide a method for processing resource allocation data that is applied to a terminal. The terminal includes, but is not limited to, a fixed terminal and/or a mobile terminal. For example, the fixed terminal includes, but is not limited to, a PC, or a TV, etc. The mobile terminal includes, but is not limited to, a mobile phone, or a tablet computer, or a wearable device, etc. As shown in FIG. 2, the method comprises the following steps:

step 201 of receiving an evaluation result of resource allocation data of a target vehicle type, wherein the evaluation result is obtained based on popularity and transaction volume of the target vehicle type in a target site within a preset time range; and

Step 202 of displaying the evaluation result.

In this way, it is possible to provide the terminal with the evaluation result of the resource allocation data of the target vehicle type, which is beneficial for the staff member to perform targeted work and services based on the evaluation result of the vehicle type, thereby improving customer experience and sales conversion rate.

In some embodiments, the method further comprises: receiving a resource adjustment suggestion corresponding to the evaluation result, and displaying the resource adjustment suggestion.

In this way, it is possible to provide the terminal with the adjustment result of the resource allocation data of the target vehicle type, which is beneficial for the staff member to perform targeted work and services based on the adjustment result of the vehicle type, thereby improving customer experience and sales conversion rate.

In some embodiments, the method further comprises: receiving a query condition, wherein the query condition includes at least the preset time range; and sending the query condition to an electronic device.

In this way, it can provide the terminal with the evaluation result of the resource allocation data of the target vehicle type and the adjustment result that meet the query condition, which is beneficial for the staff member to perform targeted work and services based on the evaluation result and adjustment result of the vehicle type, thereby improving customer experience and sales conversion rate.

FIG. 3 shows a display interface of popularity of vehicle types. As shown in FIG. 3, popularity ranking of the vehicle types in the store is displayed on the display interface. Of course, other data may also be displayed on the display interface.

The method for calculating a length of stay in the same vehicle type comprises:
calculating lengths of stay of all target persons in each vehicle type area within a preset time period, and accumulating lengths of stay in the same vehicle type area.

For the purpose of guaranteeing real-time data, data stream processing is adopted. Each vehicle type has a separate accumulator for every day; at the end of every day, each accumulator delivers the result.

In practical applications, the terminal receives a query condition time range in which is a certain day D1 in the past; the server screens out lengths of stay of each vehicle type in D1 from the database based on the query condition, and obtaining popularity ranking of the vehicle types after ranking the lengths of stay.

In practical applications, the terminal receives a query condition time range in which is a current day D-Current; the server screens out lengths of stay of each vehicle type in D-Current from the accumulators based on the query condition, and obtaining popularity ranking of the vehicle types after ranking the lengths of stay.

In practical applications, the terminal receives a query condition time range in which is a period of D1 to D2; the server screens out lengths of stay of each vehicle type in each day of D1 to D2 from the database or from the accumulators based on the query condition, grouping and accumulating total lengths of stay of each vehicle type, and obtaining popularity ranking of the vehicle types after ranking the total lengths of stay.

The salesman of the 4S store and the store can find out via the display interface how much the target person of the store is interested in each vehicle type, which provides data support for feeding back the effects of the placement and marketing activities of vehicle types, by integrating the store's promotion needs and marketing strategies. For regional corporations, dealers and manufacturers in particular, they can remotely know how much target groups visiting each stores are interested in each vehicle type without going to the stores, which provides a support for their operational decision-making and evaluating the work effects of the sales department/stores.

It should be understood that the display interface shown in FIG. 3 is an optional display method, and the present disclosure is not limited thereto.

It should also be understood that the display interface shown in FIG. 3 is only for illustrating embodiments of the present disclosure; those skilled in the art can make various apparent changes and/or substitutions based on the example shown in FIG. 3, and technical solutions derived therefrom still belong to the scope of disclosure contained in the embodiments of the present disclosure.

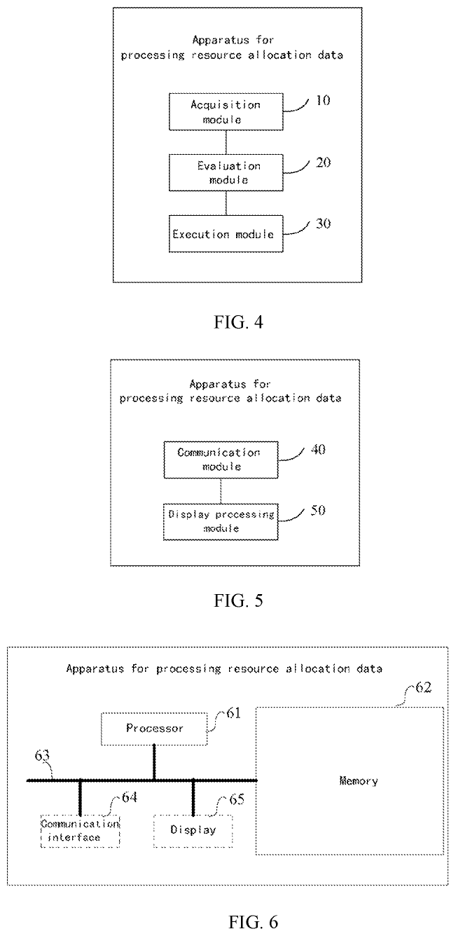

Corresponding to the above method for processing resource allocation data that is applied to a terminal, embodiments of the present disclosure provide an apparatus for processing resource allocation data. As shown in FIG. 4, the apparatus comprises: an acquisition module configured to acquire popularity and transaction volume of a target vehicle type in a target site within a preset time range; an evaluation module 20 configured to evaluate resource allocation data of the target vehicle type based on the popularity and the transaction volume to obtain an evaluation result of the resource allocation data; and an execution module 30 configured to adjust the resource allocation data or output a resource adjustment suggestion corresponding to the evaluation result, according to the evaluation result.

As an embodiment, the evaluation module 20 is configured to obtain a first comparison result according to a relationship in magnitude between the popularity and preset popularity; obtain a second comparison result according to a relationship in magnitude between the transaction volume and preset transaction volume; and determine the evaluation result based on the first comparison result and the second comparison result.

As an embodiment, the preset time range includes a first preset time range and a second preset time range; the evaluation module 20 is configured to determine a first change trend of the popularity within the first preset time range with respect to the popularity within the second preset time range; determine a second change trend of the transaction volume within the first preset time range with respect to the transaction volume within the second preset time range; and determine the evaluation result based on the first change trend and the second change trend.

As an embodiment, the evaluation result includes at least two levels; resource allocation data to be adjusted that corresponds to different levels varies in type, and/or resource allocation data to be adjusted that corresponds to different levels is adjusted in different ways.

As an embodiment, the evaluation module 20 is configured to determine the evaluation result based on the first comparison result and the second comparison result by doing at least one of: determining that the evaluation result is a first evaluation result in a case where the first comparison result indicates that the popularity is greater than or equal to the preset popularity, and the second comparison result indicates that the transaction volume is less than the preset transaction volume; determining that the evaluation result is a second evaluation result in a case where the first comparison result indicates that the popularity is less than the preset popularity, and the second comparison result indicates that the transaction volume is greater than or equal to the preset transaction volume; and determining that the evaluation result is a third evaluation result in a case where the first comparison result indicates that the popularity is less than the preset popularity, and the second comparison result indicates that the transaction volume is less than the preset transaction volume.

As an embodiment, the evaluation module 20 is configured to determine the evaluation result based on the first change trend and the second change trend by doing at least one of:

determining that the evaluation result is a first evaluation result in a case where the first change trend is an upward trend and the second trend is a downward trend; determining that the evaluation result is a second evaluation result in a case where the first change trend is a downward trend and the second trend is an upward trend; and determining that the evaluation result is a third evaluation result in a case where the first change trend is a downward trend and the second trend is a downward trend.

As an embodiment, the execution module 30 is configured to adjust the resource allocation data according to the evaluation result by doing at least one of: adjusting contents of the resource allocation data in a case where the evaluation result includes the first evaluation result, wherein the resource allocation data includes online resource allocation data and/or offline resource allocation data; adjusting contents of the offline resource allocation data in a case where the evaluation result includes the second evaluation result; and adjusting contents of the online resource allocation data and the offline resource allocation data in a case where the evaluation result includes the third evaluation result.

As an embodiment, the contents of the offline resource allocation data include at least one of a placement location, selling price, after-sales service, and push method of resource allocation data of the target vehicle type; and/or the contents of the online resource allocation data include at least one of a presentation location of relevant information, selling price, after-sales service, and push method of resource allocation data of the target vehicle type; and/or the push method of resource allocation data includes at least one of a push time of resource allocation data, an interval between two consecutive pushes of resource allocation data, and a route to push resource allocation data.

As an embodiment, the acquisition module 10 is configured to determine the total length of stay corresponding to the target vehicle type based on video images of a plurality of persons on a visit within the preset time range; and determine the popularity of the target vehicle type based on the total length of stay corresponding to the target vehicle type.

As an embodiment, the acquisition module 10 is configured to determine a vehicle type area where a target person is located, based on location information of an area where the target person appears and location information of an area where the target vehicle type is located, in the plurality of video images; determine a length of stay of the target person in the area where the target vehicle type is located in the plurality of video images, according to a capture time of the plurality of video images and the vehicle type area where the target person is located; and determine total length of stay corresponding to the target vehicle type according to lengths of stay of a plurality of the target persons in the area where the target vehicle type is located. As an embodiment, the apparatus is applied to a server; the execution module 30 is configured to send the resource adjustment suggestion corresponding to the evaluation result to a terminal in order for the terminal to display at least part of the resource adjustment suggestion via a display interface.

As an embodiment, the apparatus is applied to a terminal; the execution module 30 is configured to display at least part of the resource adjustment suggestion via a display interface of the terminal.

It should be understood by those skilled in the art that the functions implemented by each processing module in the apparatus for processing resource allocation data shown in FIG. 4 can be understood with reference to the foregoing description of the method for processing resource allocation data applied to an electronic device. It should be understood by those skilled in the art that the functions of the processing units in the apparatus for processing resource allocation data shown in FIG. 4 can be implemented by a program running on a processor, or be implemented by a specific logic circuit.

In practical applications, the specific structures of the above acquisition module 10 and evaluation module 20 may both correspond to processors. The specific structure of the processor may be a central processing unit (CPU), a micro controller unit (MCU), a digital signal processor (DSP), or a programmable logic controller (PLC), among other electronic components having processing functions or collections thereof. In the case that the apparatus for processing resource allocation data is applied to a server, the specific structure of the execution module 30 may correspond to a processor integrated with a communication interface, and the communication interface may be implemented by a communication module set (containing basic communication suite, operating system, communication module, standardized interface, protocol, etc.) and a transceiver antenna in practical applications. In the case that the apparatus for processing resource allocation data is applied to a terminal, the specific structure of the execution module 30 may correspond to a processor integrated with a display screen. The processor includes executable codes, and the executable codes are stored in a storage medium. The processor may be connected to the storage medium via a communication interface such as a bus, etc. When corresponding functions of the specific units are carried out, the executable codes are read from the storage medium and are run. The part of the storage medium for storing the executable codes is preferably a non-transitory storage medium.

The apparatus for processing resource allocation data provided by the embodiments of the present disclosure can make it possible to know data on popularity and transaction volume of a target vehicle type with higher accuracy, provide an evaluation result of the resource allocation data of the target vehicle type, and provide a reasonable adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, and customer experience and sales conversion rate can be further improved.

Corresponding to the method for processing resource allocation data that is applied to a terminal, embodiments of the present disclosure provide an apparatus for processing resource allocation data that is applied to a terminal. As shown in FIG. 5, the apparatus comprises: a communication module 40 configured to receive an evaluation result of resource allocation data of a target vehicle type; and a display processing module 50 configured to display the evaluation result, wherein the evaluation result is obtained based on popularity and transaction volume of the target vehicle type in a target site within a preset time range, and wherein the popularity is obtained based on total lengths of stay corresponding to a plurality of vehicle types within the preset time range.

In some embodiments, the communication module 40 is further configured to receive a resource adjustment suggestion corresponding to the evaluation result; the display processing module 50 is further configured to display the resource adjustment suggestion.

In some embodiments, the apparatus further comprises: an input module (not shown in FIG. 5) configured to receive a query condition, wherein the query condition includes at least the preset time range; and the communication module 40 further configured to send the query condition to an electronic device.

It should be understood by those skilled in the art that the functions implemented by each processing module in the apparatus for processing resource allocation data shown in FIG. 5 can be understood with reference to the foregoing description of the method for processing resource allocation data applied to a terminal. It should be understood by those skilled in the art that the functions of the each processing unit in the apparatus for processing resource allocation data shown in FIG. 5 can be implemented by a program running on a processor, or be implemented by a specific logic circuit.

In practical applications, the specific structures of the above communication module 40 may correspond to a communication interface. The communication interface may be implemented by a communication module set (containing basic communication suite, operating system, communication module, standardized interface, and protocol, etc.) and a transceiver antenna in practical applications. The specific structure of the display processing module 50 may correspond to a processor integrated with a display screen. The specific structure of the input module may correspond to a processor. The specific structure of the processor may be a CPU, a MCU, a DSP, or a PLC, among other electronic components having processing functions or collections thereof. The processor includes executable codes, and the executable codes are stored in a storage medium. The processor may be connected to the storage medium via a communication interface such as a bus, etc. When corresponding functions of each specific unit are carried out, the executable codes are read from the storage medium and are run. The part of the storage medium for storing the executable codes is preferably a non-transitory storage medium.

The apparatus for processing resource allocation data provided by the embodiments of the present disclosure can make it possible to know data on popularity and transaction volume of a target vehicle type with higher accuracy, provide an evaluation result of the resource allocation data of the target vehicle type, and provide a reasonable adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, and customer experience and sales conversion rate can be further improved.

Embodiments of the present disclosure further provide an apparatus for processing resource allocation data. FIG. 6 is a schematic diagram of the hardware composition structure of an apparatus for processing resource allocation data that is provided by an embodiment of the present disclosure. As shown in FIG. 6, the apparatus comprises: a memory 62, a processor 61, and a computer program stored in the memory 62 and capable of running on the processor 61. When the processor 61 executes the program, the method for processing resource allocation data applied to an electronic device or terminal that is provided by any one of the technical solutions described above is executed.

It should be understood by those skilled in the art that the functions of each processing unit in the apparatus for processing resource allocation data shown in FIG. 4 or FIG. 5 can be implemented by a program running on a processor, or be implemented by a specific logic circuit.

The apparatus for processing resource allocation data provided by the embodiments of the present disclosure can make it possible to know data on popularity and transaction volume of a target vehicle type with higher accuracy, provide an evaluation result of the resource allocation data of the target vehicle type, and further provide a reasonable adjustment plan for the resource allocation data. That helps to perform targeted work and services based on the evaluation result and adjustment plan of the resource allocation data. As a result, when a core factor that affects the transaction volume is determined based on a result of the data sorting, target vehicle type-based resource allocation can be reasonably planned, and customer experience and sales conversion rate can be further improved.

Optionally, when applied to a server, the apparatus for processing resource allocation data further comprises a communication interface 64. The communication interface 64 is used for wired or wireless communication between the apparatus for processing resource allocation data and other devices.

Optionally, when applied to a terminal, the apparatus for processing resource allocation data further comprises a display 65. The display 65 may include a liquid crystal display (LCD) and a touch panel (TP). If the screen includes a touch panel, the screen can be implemented by a touch screen to receive an input signal from a user.

It is understandable that the various components in the apparatus for processing resource allocation data are coupled together through a bus system 63. It is understandable that the bus system 63 is configured to enable connection and communication between these components. In addition to a data bus, the bus system 63 also includes a power bus, a control bus, and a status signal bus. However, for the sake of a clear description, various buses are marked as the bus system 63 in FIG. 6.

It is understandable that the memory 62 may be a volatile memory or a non-volatile memory, and may also include both volatile and non-volatile memories. The non-volatile memory may be a read only memory (ROM), a programmable read-only memory (PROM), an erasable programmable read-only memory (EPROM), an electrically erasable programmable read-only memory (EEPROM), a ferromagnetic random access memory (FRAM), a flash memory, a magnetic surface memory, a compact disc, or a compact disc read-only memory (CD-ROM). The magnetic surface memory may be a disk memory or tape memory. The volatile memory may be a random access memory (RAM), which is used as an external cache. By way of an illustrative but not restrictive description, many forms of RAM are available, such as a static random access memory (SRAM), a synchronous static random access memory (SSRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synclink dynamic random access memory (SLDRAM), and a direct rambus random access memory (DRRAM)). The memory 62 described in the embodiments of the present disclosure is intended to include, but be not limited to, these memories and a memory of any other suitable type.

The methods disclosed in the embodiments of the present disclosure described above may be applied in the processor 61 or implemented by the processor 61. The processor 61 may be an integrated circuit chip capable of signal processing. In the implementation process, each step of the methods described above can be carried out by the integrated logic circuits of the hardware in the processor 61 or by instructions in the form of software. The above processor 61 may be a general-purpose processor, a DSP, or any other programmable logic device, discrete gates or transistor logic devices, discrete hardware components, etc. The processor 61 may implement or execute various methods, steps, and logical block diagrams disclosed in the embodiments of the present disclosure. The general-purpose processor may be a microprocessor or any conventional processor. The steps in the methods disclosed in the examples of the present disclosure may be directly embodied to be executed and completed by a hardware decoding processor, or executed and completed by a combination of hardware and software modules in the decoding processor. The software module may be located in a storage medium, and the storage medium is located in the memory 62. The processor 61 reads information in the memory 62 and carries out the steps of the methods described above in combination with its hardware.

In an illustrative embodiment, the apparatus for processing resource allocation data may be implemented by one or more of an application specific integrated circuit (ASIC), a DSP, a programmable logic device (PLD), a complex programmable logic device (CPLD), an FPGA, a general-purpose processor, a controller, an MCU, a microprocessor, or any other electronic component, so as to have the methods described above carried out.

Embodiments of the present disclosure further provide a computer storage medium storing a computer-executable instruction. The computer-executable instruction is configured to execute the method for processing resource allocation data that is applied to an electronic device described in each of the foregoing embodiments, or the computer-executable instruction is configured to execute the method for processing resource allocation data that is applied to a terminal described in each of the foregoing embodiments. That is, after the computer-executable instruction is executed by a processor, the method for processing resource allocation data applied to an electronic device or terminal that is provided by any one of the technical solutions described above is implemented.

It should be understood by those skilled in the art that the functions of each program in the computer storage medium of this embodiment can be understood with reference to the relevant description of the methods for processing resource allocation data applied to an device or terminal that are described in the foregoing embodiments.

Embodiments of the present disclosure further provide a computer program causing a computer to execute the methods for processing resource allocation data that is applied to an electronic device or terminal, which are described in the embodiments of the present disclosure.

It should be understood that the apparatus and methods provided by the several embodiments of the present disclosure may be implemented in other ways. The apparatus embodiments described above are merely illustrative. For example, the units are divided according to their logical functions. In fact, they may be divided in another way in actual implementation. For example, a plurality of units or components may be combined, or integrated into another system; alternatively, some characteristics may be ignored or not be executed. In addition, the coupling or direct coupling, or the communication connection between the composition components on display or in discussion may be indirect coupling, or communication connection through some interfaces, devices or units, and may be electrical, mechanical or in any other form.

The units described above as separate components may or may not be physically separate. The components displayed as units may or may not be physical units; they may be located in one place or distributed over a plurality of network units. Some or all of the units may be selected according to actual needs to achieve the purpose of the solutions of the embodiments.

Additionally, each functional unit in each embodiment of the present disclosure may be all integrated into one processing unit; alternatively each of the units may be individually used as one unit, or two or more of them may be integrated into one unit. The integrated unit above may be implemented in the form of hardware, or in the form of hardware plus software functional units.

It is understandable to those skilled in the art that all or part of the steps in the method embodiments described above may be completed by a program instructing relevant hardware. The forgoing program may be stored in a computer readable storage medium. When the program is executed, the steps of the method embodiments described above are carried out. The storage medium includes a mobile storage device, ROM, RAM, magnetic disk, or optical disk, among other media that can store program codes.

Alternatively, when the integrated unit of the present disclosure is implemented in the form of a software function module and sold or used as an independent product, it may also be stored in a computer readable storage medium. Based on this understanding, the technical solutions of the embodiments of the present disclosure, or a part of them that contributes to the prior art can be embodied in essence in the form of a software product. The computer software product is stored in a storage medium, and includes several instructions for causing a computer device (which may be a personal computer, a server, a network device, etc.) to execute all or part of the method described in each of the embodiments of the present disclosure. The foregoing storage medium includes a removable storage device, a ROM, a RAM, a magnetic disk, or an optical disk, among other media capable of storing program codes.

Optional implementations of the present disclosure have been described above. However, the protection scope of the present disclosure is not limited to them. Changes or substitutions within the technical scope disclosed in the present disclosure that those skilled in the art can think of with easy should be covered by the protection scope of the present disclosure. Therefore, the protection scope of the present disclosure should be limited to the claims.

What is claimed is:

1. A method for processing resource allocation data, the method comprising:
acquiring popularity and transaction volume of a target vehicle type in a target site within a preset time range;
evaluating resource allocation data of the target vehicle type based on the popularity and the transaction volume to obtain an evaluation result of the resource allocation data; and
adjusting the resource allocation data or outputting a resource adjustment suggestion corresponding to the evaluation result, according to the evaluation result.

2. The method according to claim 1, wherein evaluating the resource allocation data of the target vehicle type based on the popularity and the transaction volume to obtain the evaluation result of the resource allocation data comprises:
obtaining a first comparison result according to a relationship in magnitude between the popularity and preset popularity;
obtaining a second comparison result according to a relationship in magnitude between the transaction volume and preset transaction volume; and
determining the evaluation result based on the first comparison result and the second comparison result.

3. The method according to claim 1, wherein the preset time range includes a first preset time range and a second preset time range;
evaluating the resource allocation data of the target vehicle type based on the popularity and the transaction volume to obtain the evaluation result of the resource allocation data comprises:
determining a first change trend of the popularity within the first preset time range with respect to the popularity within the second preset time range;
determining a second change trend of the transaction volume within the first preset time range with respect to the transaction volume within the second preset time range; and
determining the evaluation result based on the first change trend and the second change trend.

4. The method according to claim 2, wherein the evaluation result includes at least two levels;
resource allocation data to be adjusted that corresponds to different levels varies in type, and/or resource allocation data to be adjusted that corresponds to different levels is adjusted in different ways.

5. The method according to claim 3, wherein the evaluation result includes at least two levels;
resource allocation data to be adjusted that corresponds to different levels varies in type, and/or resource allocation data to be adjusted that corresponds to different levels is adjusted in different ways.

6. The method according to claim 2, wherein determining the evaluation result based on the first comparison result and the second comparison result comprises at least one of:
determining that the evaluation result is a first evaluation result in a case where the first comparison result indicates that the popularity is greater than or equal to the preset popularity, and the second comparison result indicates that the transaction volume is less than the preset transaction volume;
determining that the evaluation result is a second evaluation result in a case where the first comparison result indicates that the popularity is less than the preset popularity, and the second comparison result indicates that the transaction volume is greater than or equal to the preset transaction volume; and
determining that the evaluation result is a third evaluation result in a case where the first comparison result indicates that the popularity is less than the preset popularity, and the second comparison result indicates that the transaction volume is less than the preset transaction volume.

7. The method according to claim 3, wherein determining the evaluation result based on the first change trend and the second change trend comprises at least one of:
determining that the evaluation result is a first evaluation result in a case where the first change trend is an upward trend and the second trend is a downward trend;
determining that the evaluation result is a second evaluation result in a case where the first change trend is a downward trend and the second trend is an upward trend; and
determining that the evaluation result is a third evaluation result in a case where the first change trend is a downward trend and the second trend is a downward trend.

8. The method according to claim 6, wherein adjusting the resource allocation data according to the evaluation result comprises at least one of:
adjusting contents of the resource allocation data in a case where the evaluation result includes the first evaluation result, wherein the resource allocation data includes online resource allocation data and/or offline resource allocation data;
adjusting contents of the offline resource allocation data in a case where the evaluation result includes the second evaluation result; and
adjusting contents of the online resource allocation data and the offline resource allocation data in a case where the evaluation result includes the third evaluation result.

9. The method according to claim 7, wherein adjusting the resource allocation data according to the evaluation result comprises at least one of:
adjusting contents of the resource allocation data in a case where the evaluation result includes the first evaluation result, wherein the resource allocation data includes online resource allocation data and/or offline resource allocation data;
adjusting contents of the offline resource allocation data in a case where the evaluation result includes the second evaluation result; and
adjusting contents of the online resource allocation data and the offline resource allocation data in a case where the evaluation result includes the third evaluation result.

10. The method according to claim 8, wherein the contents of the offline resource allocation data include at least one of a placement location, selling price, after-sales service, and push method of resource allocation data of the target vehicle type; and/or
the contents of the online resource allocation data include at least one of a presentation location of relevant information, selling price, after-sales service, and push method of resource allocation data of the target vehicle type; and/or
the push method of resource allocation data includes at least one of a push time of resource allocation data, an interval between two consecutive pushes of resource allocation data, and a route to push resource allocation data.

11. The method according to claim 9, wherein the contents of the offline resource allocation data include at least one of a placement location, selling price, after-sales service, and push method of resource allocation data of the target vehicle type; and/or
the contents of the online resource allocation data include at least one of a presentation location of relevant information, selling price, after-sales service, and push method of resource allocation data of the target vehicle type; and/or
the push method of resource allocation data includes at least one of a push time of resource allocation data, an interval between two consecutive pushes of resource allocation data, and a route to push resource allocation data.

12. The method according to claim 1, wherein acquiring the popularity of the target vehicle type in the target site within the preset time range comprises:
determining total length of stay corresponding to the target vehicle type based on video images of a plurality of persons on a visit within the preset time range; and
determining the popularity of the target vehicle type based on the total length of stay corresponding to the target vehicle type.

13. The method according to claim 12, wherein determining the total length of stay corresponding to the target vehicle type based on the video images of the plurality of persons on a visit within the preset time range comprises:
determining a vehicle type area where a target person is located, based on location information of an area where the target person appears and location information of an area where the target vehicle type is located, in the plurality of video images;
determining a length of stay of the target person in the area where the target vehicle type is located in the plurality of video images, according to a capture time of the plurality of video images and the vehicle type area where the target person is located; and
determining the total length of stay corresponding to the target vehicle type according to lengths of stay of a plurality of the target person in the area where the target vehicle type is located.

14. The method according to claim 1, wherein the method is applied to a server; outputting the resource adjustment suggestion corresponding to the evaluation result according to the evaluation result comprises: sending the resource adjustment suggestion corresponding to the evaluation result to a terminal in order for the terminal to display at least part of the resource adjustment suggestion via a display interface; or,
wherein the method is applied to a terminal; outputting the resource adjustment suggestion corresponding to the evaluation result according to the evaluation result comprises: displaying at least part of the resource adjustment suggestion corresponding to the evaluation result via a display interface of the terminal.

15. An apparatus for processing resource allocation data, the apparatus comprising:
a processor; and
a memory configured to store processor-executable instructions,
wherein the processor is configured to invoke the instructions stored in the memory, so as to:
acquire popularity and transaction volume of a target vehicle type in a target site within a preset time range;
evaluate resource allocation data of the target vehicle type based on the popularity and the transaction volume to obtain an evaluation result of the resource allocation data; and
adjust the resource allocation data or output a resource adjustment suggestion corresponding to the evaluation result, according to the evaluation result.

16. The apparatus according to claim 15, wherein the processor is configured to:
obtain a first comparison result according to a relationship in magnitude between the popularity and preset popularity;
obtain a second comparison result according to a relationship in magnitude between the transaction volume and preset transaction volume;
and determine the evaluation result based on the first comparison result and the second comparison result.

17. The apparatus according to claim 15, wherein the preset time range includes a first preset time range and a second preset time range; the processor is configured to:
determine a first change trend of the popularity within the first preset time range with respect to the popularity within the second preset time range;
determine a second change trend of the transaction volume within the first preset time range with respect to the transaction volume within the second preset time range;
and determine the evaluation result based on the first change trend and the second change trend.

18. The apparatus according to claim 16, wherein the processor is configured to:
determine the evaluation result based on the first comparison result and the second comparison result by doing at least one of:
determining that the evaluation result is a first evaluation result in a case where the first comparison result indicates that the popularity is greater than or equal to the preset popularity, and the second comparison result indicates that the transaction volume is less than the preset transaction volume;
determining that the evaluation result is a second evaluation result in a case where the first comparison result indicates that the popularity is less than the preset popularity, and the second comparison result indicates that the transaction volume is greater than or equal to the preset transaction volume;
and determining that the evaluation result is a third evaluation result in a case where the first comparison result indicates that the popularity is less than the preset popularity, and the second comparison result indicates that the transaction volume is less than the preset transaction volume.

19. The apparatus according to claim 17, wherein the processor is configured to determine the evaluation result based on the first change trend and the second change trend by doing at least one of:
determining that the evaluation result is a first evaluation result in a case where the first change trend is an upward trend and the second trend is a downward trend;
determining that the evaluation result is a second evaluation result in a case where the first change trend is a downward trend and the second trend is an upward trend;
and determining that the evaluation result is a third evaluation result in a case where the first change trend is a downward trend and the second trend is a downward trend.

20. A non-transitory computer storage medium storing computer program instructions, wherein when the computer program instructions are executed by a processor, the processor is caused to perform the operations of:
acquiring popularity and transaction volume of a target vehicle type in a target site within a preset time range;
evaluating resource allocation data of the target vehicle type based on the popularity and the transaction volume to obtain an evaluation result of the resource allocation data; and
adjusting the resource allocation data or outputting a resource adjustment suggestion corresponding to the evaluation result, according to the evaluation result.
